(19) United States
(12) Patent Application Publication
(10) Pub. No.: US 2025/0123399 A1
(43) Pub. Date: Apr. 17, 2025

(54) OBSCURANT REDUCTION FOR SENSOR WINDOW

(71) Applicant: Luminar Technologies, Inc., Orlando, FL (US)

(72) Inventors: Lawrence Shah, Winter Park, FL (US); Morris B. Bowers, Oviedo, FL (US); Liviu I. Voicu, Casselberry, FL (US)

(21) Appl. No.: 18/907,120

(22) Filed: Oct. 4, 2024

Related U.S. Application Data
(60) Provisional application No. 63/589,395, filed on Oct. 11, 2023.

(51) Int. Cl. G01S 17/931; G01S 7/48; G01S 7/481; G01S 7/497; G01S 17/10

(52) U.S. Cl. CPC G01S 17/931; G01S 7/4802; G01S 7/4813; G01S 7/4817; G01S 17/10; G01S 2007/4977

(57) ABSTRACT

In one embodiment, a sensor includes a window, a light source that can emit an optical signal toward the window, a receiver to detect an optical signal reflected off a target and received through the window, and a controller to determine a characteristic of the target. The emitted optical signal is capable of being used to reduce an obscurant on the window by absorption, as well as to scatter off of targets located in the environment of the sensor to obtain information about that environment.

### CROSS REFERENCE TO OTHER APPLICATIONS

This application claims priority to U.S. Provisional Patent Application No. 63/589,395 entitled OBSCURANT REDUCTION FOR SENSOR WINDOW filed Oct. 11, 2023 which is incorporated herein by reference for all purposes.

### BACKGROUND OF THE INVENTION

Light detection and ranging (lidar) is a technology that can be used to measure distances to remote targets. A lidar system may be referred to as a sensor or sensor system. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

The lidar system may include a window through which the light source directs light. It is undesirable to have a substance accumulate on or near the window that blocks or obscures the light such as water, ice, frost, dew, mist, or fog. Currently, lidar systems may experience difficulties detecting targets during such conditions, which may lead the lidar system to fail to detect targets located beyond water, ice, frost, dew, mist, or fog existing on or near the window of the lidar system or on a windshield between the lidar system and targets.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOV_{L}) and receiver field of view (FOV_{R}) for a lidar system.

FIG. 5 illustrates an example unidirectional scan pattern that includes multiple pixels and multiple scan lines.

FIG. 6 illustrates an example sensor with a light source and receiver within a housing, which includes a window partially coated by an obscurant.

FIGS. 7-9 illustrate examples of sensor windows that are free from obscurant, fully obscured, and partially obscured, respectively.

FIG. 10 illustrates an example sensor with a window behind a windshield where a gap exists between them.

FIG. 11 illustrates an example sensor with a window and a windshield without a gap between them.

FIG. 12 illustrates an example sensor with a windshield in front of the sensor where the sensor housing does not include a window.

FIG. 13 illustrates the relationship between a wavelength of light and its absorption by water.

FIG. 14 illustrates an example method for reducing an obscurant on a window of a sensor.

FIG. 15 illustrates an example computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Generally speaking, a light source (e.g., a fiber laser or a diode laser) in a lidar system transmits light pulses through a window of the lidar system. The light pulses are directed by a scanner across a field of regard of the lidar system, and light from the light pulses is scattered by one or more remote targets, transmitted through the window, and detected at a receiver in the lidar system. When the window has an obscurant such as water, ice, frost or fog on its interior or exterior surface, emitted light pulses may be hindered from being transmitted across the field of regard to a remote target, and return light pulses may be hindered from being detected at the receiver. Depending on the type and extent of obscurant existing on or near the window, it may block light pulses completely or partially. To clear the line-of-sight (LOS) through the window, a light source may be used to reduce the obscurant via heating by optical absorption of the light, to cause melting, sublimation, or evaporation of the obscurant. The lidar system's light source, which typically is used to send optical signals into the environment of the lidar system for the purpose of gathering information, may be used as the light source configured to reduce an obscurant. When an obscurant is detected, the light source may operate to optimize absorption of the light by the obscurant. The absorption of light by the obscurant generally facilitates removal or reduction of, for example, water, ice, frost, dew, mist, or fog from the surface of the window. In this way, the light source may be a particularly efficient and effective tool for removing obscurants from the sensor window.

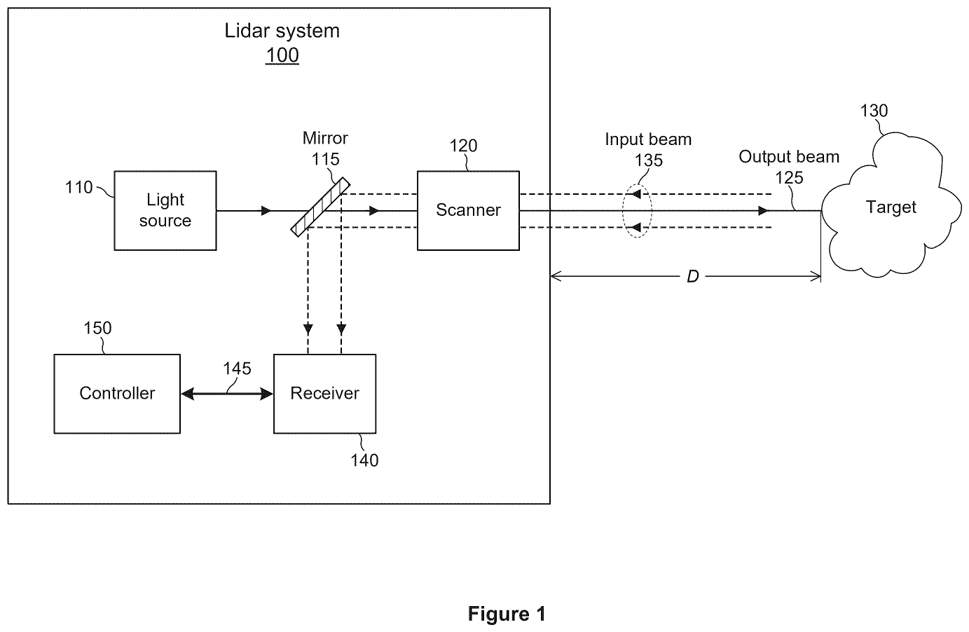

FIG. 1 illustrates an example light detection and ranging (lidar) system 100. A lidar system 100 may be referred to as a laser ranging system, a laser radar system, a LIDAR system, a lidar sensor, or a laser detection and ranging (LADAR or ladar) system. A lidar system 100 may include a light source 110, mirror 115, scanner 120, receiver 140, or controller 150 (which may be referred to as a processor). The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. A relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of light of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

The output beam 125 may include or may be referred to as an optical signal, output optical signal, emitted optical signal, output light, emitted pulse of light, laser beam, light beam, optical beam, emitted beam, transmitted beam of light, emitted light, or beam. The input beam 135 may include or may be referred to as a received optical signal, received pulse of light, input pulse of light, input optical signal, return beam, received beam, received beam of light, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

A receiver 140 may receive or detect photons from input beam 135 and produce one or more representative electrical signals. For example, the receiver 140 may produce an output electrical signal 145 that is representative of the input beam 135, and the electrical signal 145 may be sent to controller 150. A receiver 140 or controller 150 may include a processor, a computer system, an ASIC, an FPGA, or other suitable computing circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T may represent a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. A distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

A light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses of light with a pulse duration of approximately 1-5 ns. As another example, light source 110 may be a pulsed laser that produces pulses of light at a pulse repetition frequency of approximately 100 kHz to 10 MHz or a pulse period (e.g., a time between consecutive pulses of light) of approximately 100 ns to 10 μs. The pulse period τ may be related to the pulse repetition frequency (PRF) by the expression τ=1/PRF. For example, a pulse period of 1.33 μs corresponds to a PRF of approximately 752 kHz. Light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

A light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. An output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, or 100 μJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

A light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. A light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

A light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. An optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by a SOA, which in turn is followed by a fiber-optic amplifier. For example, the seed laser diode may produce relatively low-power seed pulses which are amplified by the SOA, and the fiber-optic amplifier may further amplify the optical pulses.

A light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

A light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd: YAG crystal. A DPSS laser with a Nd: YAG gain medium may produce light at a wavelength between approximately 1300 nm and approximately 1400 nm, and the Nd: YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

An output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

A lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

A lidar system 100 may include a telescope, one or more lenses, or one or more mirrors configured to expand, focus, collimate, or steer the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

The mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

A lidar system 100 may include a scanner 120 configured to scan an output beam 125 across a field of regard of the lidar system 100. As an example, scanner 120 may include one or more scan mirrors configured to pivot, rotate, oscillate, or move in an angular manner about one or more rotation axes. The output beam 125 may be reflected by a scan mirror, and as the scan mirror pivots or rotates, the reflected output beam 125 may be scanned in a corresponding angular manner. As an example, a scan mirror may be configured to periodically pivot back and forth over a 30-degree range, which results in the output beam 125 scanning back and forth across a 60-degree range (e.g., a Θ-degree rotation by a scan mirror results in a 2Θ-degree angular scan of output beam 125).

A scan mirror (which may be referred to as a scanning mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scan mirror attached to a galvanometer scanner configured to pivot back and forth over a 1° to 30° angular range. As another example, a scanner 120 may include a scan mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

A scanner 120 may be configured to scan an output beam 125 (which may include at least a portion of the light emitted by light source 110) across a field of regard of a lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scan mirror that rotates over a 30-degree range may produce an output beam 125 that scans across a 60-degree range (e.g., a 60-degree FOR). A lidar system 100 may have a FOR of approximately 10°, 20°, 40°, 60°, 120°, 360°, or any other suitable FOR.

A scanner 120 may be configured to scan an output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. A scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is different from the first direction (e.g., the first and second directions may be approximately orthogonal to one another, or the second direction may be oriented at any suitable non-zero angle with respect to the first direction). As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. A scanner 120 may be referred to as a beam scanner, optical scanner, or laser scanner.

One or more scan mirrors may be communicatively coupled to a controller 150 which may control the scan mirror(s) so as to guide the output beam 125 in a desired direction downrange or along a desired scan pattern. A scan pattern may refer to a pattern or path along which the output beam 125 is directed. As an example, scanner 120 may include two scan mirrors configured to scan the output beam 125 across a 60° horizontal FOR and a 20° vertical FOR. The two scan mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

A lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). A scanner 120 may include a solid-state scanner and a mechanical scanner. For example, a scanner 120 may include an optical phased array scanner configured to scan an output beam 125 in one direction and a galvanometer scanner that scans the output beam 125 in an approximately orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

A lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may include or may be referred to as a photoreceiver, optical receiver, optical sensor, detector, photodetector, or optical detector. A lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and a n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may receive an input beam 135 that includes an optical pulse, and the detector may produce a pulse of electrical current that corresponds to the received optical pulse. A detector may have an active region or an avalanche-multiplication region that includes silicon, germanium, InGaAs, indium aluminum arsenide (InAlAs), InAsSb (indium arsenide antimonide), AlAsSb (aluminum arsenide antimonide), AlInAsSb (aluminum indium arsenide antimonide), or silicon germanium (SiGe). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

A receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a photocurrent (e.g., a pulse of current produced by an APD in response to a received optical pulse) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

A controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. One or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to another computing system located elsewhere within the lidar system 100 or outside the lidar system 100. A controller 150 may include any suitable arrangement or combination of logic circuitry, analog circuitry, or digital circuitry.

A controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. The frequency, period, duration, pulse energy, peak power, average power, or wavelength of the optical pulses produced by light source 110 may be adjusted based on instructions, a control signal, or trigger pulses provided by controller 150. A controller 150 may be coupled to light source 110 and receiver 140, and the controller 150 may determine a time-of-flight value for an optical pulse based on timing information associated with a time when the pulse was emitted by light source 110 and a time when a portion of the pulse (e.g., input beam 135) was detected or received by receiver 140. A controller 150 may include circuitry that performs signal amplification, sampling, filtering, signal conditioning, analog-to-digital conversion, time-to-digital conversion, pulse detection, threshold detection, rising-edge detection, or falling-edge detection.

A lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. An operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100.

A lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

A lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). A point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

A lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. A target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. A target may be referred to as an object.

A lidar system 100 may include a light source 110, scanner 120, and receiver 140 that are packaged together within a single housing, where a housing may refer to a box, case, or enclosure that holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. One or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

A light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. A lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

One or more lidar systems 100 may be integrated into a vehicle. As an example, a truck may include a single lidar system 100 with a 60-degree to 180-degree horizontal FOR directed towards the front of the truck. As another example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. A vehicle may refer to a mobile machine configured to transport people or cargo. For example, a vehicle may include a car used for work, commuting, running errands, or transporting people. As another example, a vehicle may include a truck used to transport commercial goods to a store, warehouse, or residence. A vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., a drone), or spacecraft. A vehicle may include an internal combustion engine or an electric motor that provides propulsion for the vehicle.

One or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is located in a blind spot.

One or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

An autonomous vehicle may be referred to as an autonomous car, driverless car, self-driving car, robotic car, or unmanned vehicle. An autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

An autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

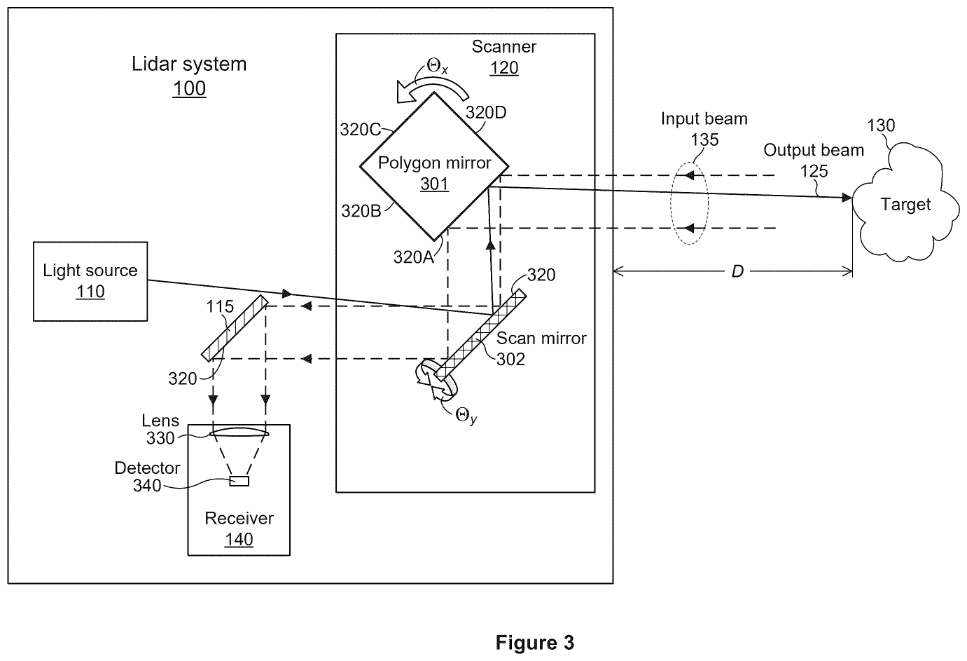

An optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. The distance to a remote target 130 may be determined based on the round-trip time of flight for a pulse of light to travel to the target 130 and back. Alternatively, a lidar system 100 may be configured to operate as a frequency-modulated continuous-wave (FMCW) lidar system and may include a light source 110 that produces a frequency-modulated optical signal. For example, output beam 125 in FIG. 1 or FIG. 3 may include FM light. Additionally, the light source may also produce local-oscillator (LO) light that is frequency modulated. A FMCW lidar system may use frequency-modulated light to determine the distance to a remote target 130 based on a frequency of received light (which includes emitted light scattered by the remote target) relative to a frequency of the LO light. A round-trip time for the emitted light to travel to a target 130 and back to the lidar system may correspond to a frequency difference between the received scattered light and the LO light. A larger frequency difference may correspond to a longer round-trip time and a greater distance to the target 130. The frequency difference between the received scattered light and the LO light may be referred to as a beat frequency.

A light source 110 for a FMCW lidar system may include (i) a direct-emitter laser diode, (ii) a seed laser diode followed by a SOA, (iii) a seed laser diode followed by a fiber-optic amplifier, or (iv) a seed laser diode followed by a SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of a FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

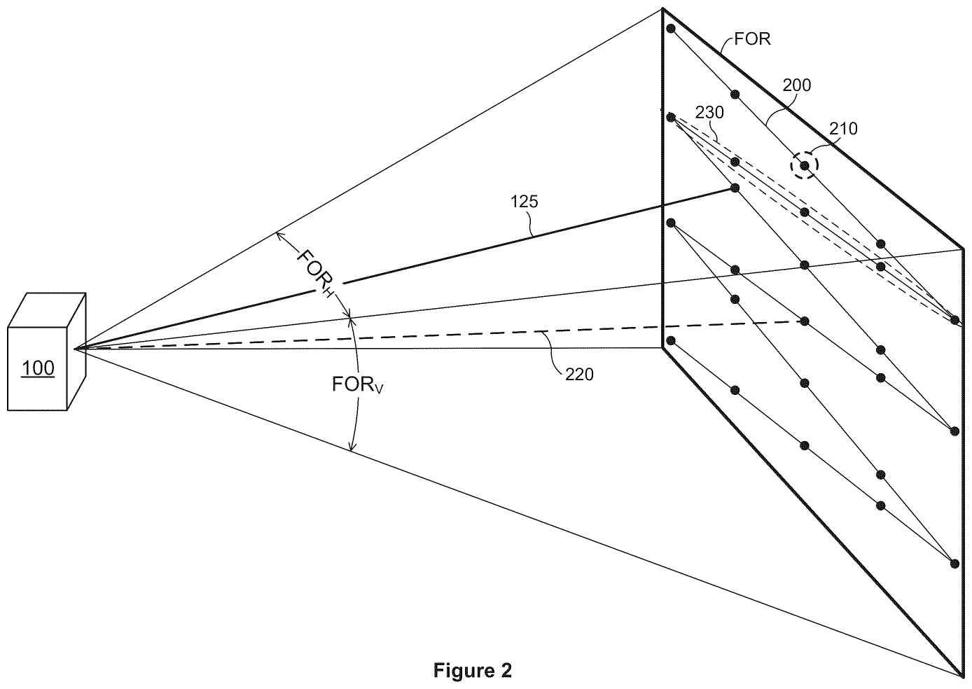

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 by the output beam 125 may correspond to the capture of a single frame or a single point cloud. A scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 120°×20°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. A reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a non-zero horizontal angle or a non-zero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +° vertical with respect to reference line 220. Optical beam 125 may be referred to as having an azimuth of −15° and an altitude of +3° relative to reference line 220. An azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

A scan pattern 200 may include multiple pixels 210, and each pixel 210 may be associated with one or more optical pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. A complete cycle or traversal of a scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200.

A pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated pulse of light was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). An angular value may be determined based at least in part on a position of a component of a scanner 120. As an example, an azimuth or altitude value associated with a pixel 210 may be determined from an angular position of one or more corresponding scan mirrors of the scanner 120.

FIG. 3 illustrates an example lidar system 100 with an example rotating polygon mirror 301. A scanner 120 may include a polygon mirror 301 configured to scan output beam 125 along a first direction and a scan mirror 302 configured to scan output beam 125 along a second direction different from the first direction (e.g., the first and second directions may be approximately orthogonal to one another, or the second direction may be oriented at any suitable non-zero angle with respect to the first direction). In the example of FIG. 3, scanner 120 includes two scan mirrors: (1) a polygon mirror 301 that rotates along the Θₓ direction and (2) a scan mirror 302 that oscillates back and forth along the Θ_{y} direction. The output beam 125 from light source 110, which passes alongside mirror 115, is reflected by reflecting surface 320 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. The detector 340 may be a PN photodiode, a PIN photodiode, an APD, a SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R may be greater than or equal to 70%, 80%, 90%, 95%, 98%, or 99%).

A polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. A polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

A polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

A polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or, 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In FIG. 3, the output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. A lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 320 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 320, and then the output beam 125 is directed to the polygon mirror 301, where it is reflected by reflective surface 320A.

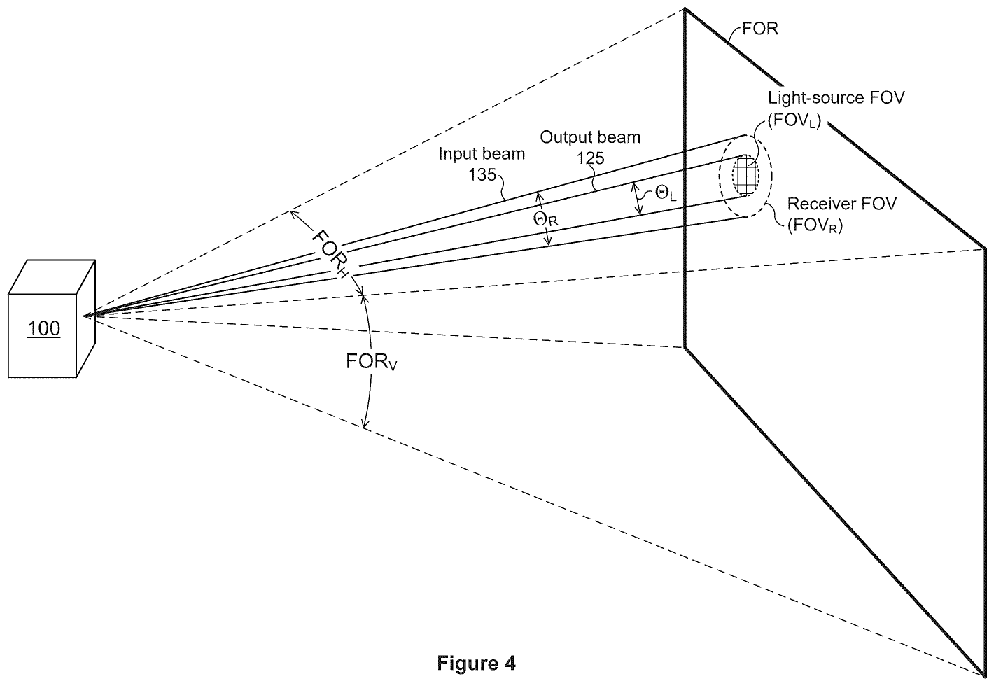

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). A light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

A scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. The light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

An output beam of light 125 emitted by light source 110 may be a collimated optical beam having any suitable beam divergence, such as for example, a full-angle beam divergence Θ_{L} of approximately 0.5 to 10 milliradians (mrad). A divergence Θ_{L} of output beam 125 (which may be referred to as an angular size of the output beam) may correspond to an angular measure of an increase in beam size (e.g., a beam radius or beam diameter) as output beam 125 travels away from light source 110 or lidar system 100. An output beam 125 may have a substantially circular cross section with a beam divergence characterized by a single divergence value. As an example, an output beam 125 with a circular cross section and a full-angle beam divergence Θ_{L} of 2 mrad may have a beam diameter or spot size of approximately 20 cm at a distance of 100 m from lidar system 100. An output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

The angular size Θ_{R} of a FOV_{R} may correspond to an angle over which the receiver 140 may receive and detect light. The receiver field of view may be any suitable size relative to the light-source field of view. As an example, the receiver field of view may be smaller than, substantially the same size as, or larger than the angular size of the light-source field of view. The light-source field of view may have an angular size of less than or equal to 50 milliradians, and the receiver field of view may have an angular size of less than or equal to 50 milliradians. The FOV_{L} may have any suitable angular size Θ_{L}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular size Θ_{R},such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. The light-source field of view and the receiver field of view may have approximately equal angular sizes. As an example, Θ_{L} and Θ_{R} may both be approximately equal to 0.5 mrad, 1 mrad, or 2 mrad. Alternatively, the receiver field of view may be larger than the light-source field of view, or the light-source field of view may be larger than the receiver field of view. As an example, Θ_{L} may be approximately equal to 1 mrad, and Θ_{R} may be approximately equal to 2 mrad. As another example, Θ_{R} may be approximately L times larger than Θ_{L}, where L is any suitable factor, such as for example, 1.1, 1.2, 1.5, 2, 3, 5, or 10.

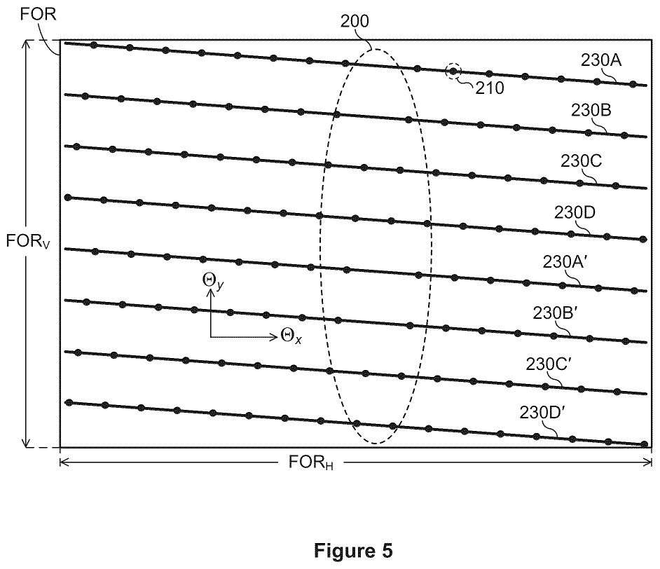

FIG. 5 illustrates an example unidirectional scan pattern 200 that includes multiple pixels 210 and multiple scan lines 230. A scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. A scan pattern 200 in which the scan lines 230 are scanned in two directions (e.g., alternately scanning from right to left and then from left to right) may be referred to as a bidirectional scan pattern 200, and a scan pattern 200 in which the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). Scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. Each scan line 230 in a unidirectional scan pattern 200 may be a separate line that is not directly connected to a previous or subsequent scan line 230.

A unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. One full revolution of a N-sided polygon mirror may correspond to N successive scan lines 230 of a unidirectional scan pattern 200. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

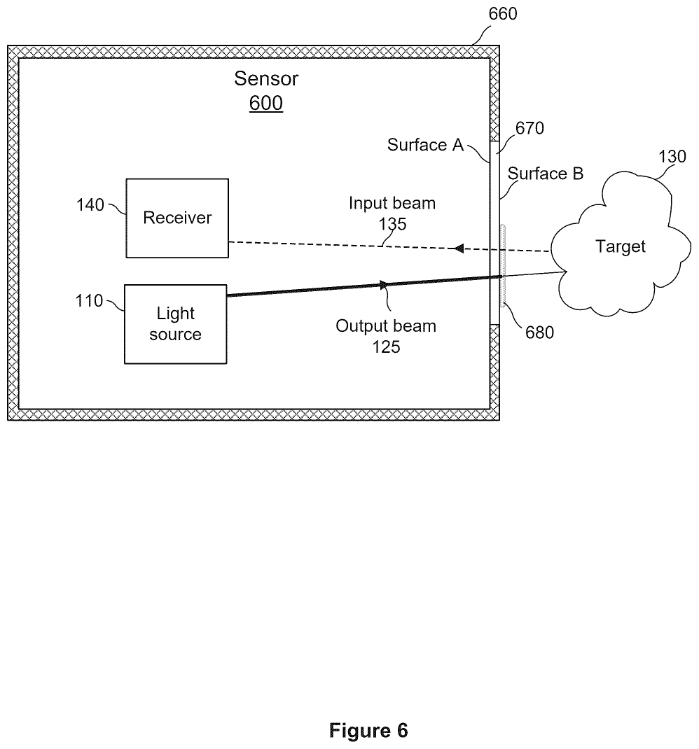

FIG. 6 illustrates an example sensor 600 with a light source 110 and receiver 140 within a housing 660, which includes a window 670 partially coated by an obscurant 680.

A sensor 600 may be a lidar system or other sensor system that emits and receives optical signals. Although this disclosure describes or illustrates example embodiments of lidar systems 100, the embodiments described or illustrated herein may also be applied, where appropriate, to other types of sensors, for example range-finders, proximity sensors, moisture sensors, light detectors, and motion detectors, among others. As an example, the invention could be utilized in other applications utilizing a wavelength with strong water absorption and rapid beam scanning.

The sensor 600 may include a housing 660. A housing 660 may refer to a box, case, or enclosure that holds or contains all or part of a sensor system 600. A housing 660 may or may not include a window 670 through which beams 125 and 135 pass.

A window 670 may also be referred to as an internal window, and may be made from any suitable substrate material, such as for example, glass or plastic (e.g., polycarbonate, acrylic, cyclic-olefin polymer, or cyclic-olefin copolymer). The window 670 may include an interior surface (surface A) and an exterior surface (surface B), and surface A or surface B may include a dielectric coating having particular reflectivity values at particular wavelengths. A window 670 may include a conductive heating mechanism, or physical mechanisms such as fluid or wipers, or any other suitable means for reducing water, ice, fog, dew, mist, or frost on the window 670. A conductive heating mechanism may include or may be referred to as a heating mechanism, a heating element, a heating element mechanism, or an electric heating element. As an example, a window may be the windshield of a vehicle, and the sensor may be operating within that vehicle. In certain embodiments, a sensor may utilize a mechanism that cleans the windshield of a car to clear obscurants for the sensor. As an example, a windshield, behind which the sensor is attached, may be cleared by windshield wipers or windshield washer fluid, or may include a heating element. Alternatively, a window 670 in a sensor 600 may include none of these. A sensor may use a light source 110 to reduce window obscurants, either alone or in addition to other cleaning mechanisms like those discussed herein.

An obscurant is something that obscures the ability of the sensor to collect data across the field of regard of the sensor. It may be referred to as an obstruction, and may include, for example, rain, frost, fog, ice, dew, mist, or water on or near the window. An obscurant may form on the interior or exterior surface of a window. Reducing the obscurant may include melting, sublimating, or evaporating the obscurant from the window by optical absorption.

In some embodiments, sensor 600 may include a housing 660 with a window 670, and a light source 110 that emits an optical signal 125 toward the window 670. After being reflected from target 130, a received optical signal 135 may pass through the window 670 and may be received by a receiver 140 of the sensor 600. If an obscurant 680 exists on or near the window 670, the light source 110 may be configured to emit optical signals in such a way that the obscurant 680 absorbs some or all of the emitted optical signal 125 to reduce the obscurant 680. For example, the obscurant may be reduced by absorption such that it covers less area of the window 670, or by a reduction in the thickness of the obscurant, such as melting ice that covers all or part of the window 670. In certain embodiments, an obscurant 680 may experience significant heat contribution from the optical signal being absorbed. As an example, the light source 110 may clear a 0.1, 0.4, 0.7, 1.0 or 1.5 mm thick ice layer in an ambient environment experiencing below freezing temperatures.

The sensor 600 may include one or more light sources 110. A light source may be used to gather information about the environment that the sensor is operating in, or to reduce an obscurant 680, or both. The light sources may be similar or the same, for example operating at the same power and wavelength (as an example, in a two or more “eye” lidar system configuration), or they may be different to accomplish different functions (e.g. one or more light sources for obtaining sensor data and a different light source for reducing obscurants on the window). In some embodiments, one light source 110 is used to both gather information about the environment and reduce obscurants 680 on or near the window 670 when an obscurant is detected. Such a configuration, where one light source is utilized for both purposes, may be particularly advantageous in a sensor to conserve space, reduce power needs, optimize cost of the system, reduce complexity, etc.

In some embodiments, a light source may emit an optical signal toward a window. The optical signal may (i) reduce an obscurant on the window, and (ii) scatter off of a target in order to determine information about the environment of the sensor. As an example, in an initial interval of time, the optical signals may primarily be absorbed and may reduce ice existing on the window by optical absorption. In a later interval of time, once at least a portion of the window has been cleared of ice, the emitted optical signals may do both (continue reducing the ice that still exists on parts of the window, as well as using the cleared portion of the window to scatter off of a target for ranging). In this embodiment, some emitted optical signals may reduce the ice while others perform ranging at the same time. At a later time, the light source may be used primarily for ranging, once the obscurant has been removed.

In some implementations, the sensor 600 also includes a controller 150 configured to adjust a characteristic of the light source 110 in order to increase the sensor's ability to reduce the obscurant 680 on the window 670. A characteristic of the light source 110 may include any suitable light source characteristic, such as, for example, a pulse rate, pulse frequency, pulse repetition frequency, peak power, amplitude, average power, pulse energy, wavelength, coherence, etc. of the light source. As an example, the controller 150 may be configured to change the peak power, average power or pulse energy of the emitted optical signal by communicating with the light source 110 in order to reduce an obscurant 680 existing on the window 670. For example, the controller 150 may increase the average power to reduce an obscurant 680. In certain embodiments, the controller 150 may increase the average power of light source 110 in order to melt frost or ice existing on the external surface of the window 670. The controller 150 may further change the average power or other characteristics of the light source 110 depending on a detected amount or coverage of the obscurant. In certain embodiments, the light source 110 average power may be increased again to attempt to remove the obscurant 680, or the average power may be reduced once the obscurant is reduced below a threshold value, or after a set amount of time has passed, for example to maintain eye safety or to conserve power. An obstruction detection system may provide input or feedback on the current state of the obscurant to inform changes to the light source characteristics.

In some implementations, the sensor 600, also includes a scanner 120. The scanner 120 may be configured to scan the emitted optical signal across a field of regard of the sensor 600. In some implementations, scanning the field of regard of the sensor may result in scanning the emitted optical signal across some or all of the window 670 that the emitted optical signal is emitted toward. In some implementations, the controller 150 may adjust the scan pattern of the sensor 600 by communicating with the scanner 120 in order to scan the emitted optical signal across the window 670 in such a way as to optimize the reduction of an obscurant 680 existing on the window 670. As an example, if the sensor 600 detects an obscurant 680 such as frost on a specific area of the window 670, the controller may cause the scanner 120 to focus the scan pattern in that area of the window 670, or slow the scan speed in that area, until frost is no longer detected there. In certain embodiments, to improve the ability of the light source 110 to clear an obscurant, a light source's 110 power may be concentrated particularly in the center of the window 670. In some embodiments, the scanner 120 may utilize a change in the speed of beam scanning to improve cleaning by light absorption. For example, the scanner 120 may slow the rate of beam scanning in a particular region to apply an increased power of light in that region, thereby increasing the rate of obscurant reduction.

As another example, it may be desirable to minimize the elevation scan to maximize optical absorption while maintaining eye safety. In that case, the small elevation region being illuminated would clear more quickly, and then that area of focus could be slowly changed to clear the window. The area of focus could initially be at the top of the FOR and then progress down, or the reverse, or any other suitable method could be used for focusing on an area of the window smaller than the FOR, while moving to a new area as each one is cleared. As another example, the area of focus may initially be located near the middle of the FOR and then the area of focus may be moved outwards from there.

In some implementations, the sensor 600 is a lidar system which emits an optical signal 125 that comprises a pulse of light.

In certain embodiments, the sensor 600 includes an obstruction detection system that is configured to monitor the obscurant 680 on the window 670. Such an obstruction detection system may also be configured to give an indication of the status of the obscurant to the sensor 600 or to a controller 150 of the system. A status may include, for example, the existence of an obscurant or an amount, extent, thickness, type, or coverage of an obscurant 680 on the window 670. An obstruction detection system may also be referred to as an obstruction detector, an obscurant detector, or a monitor. An obstruction detection system may use any suitable means to determine an obstruction exists, as an example it may use a separate detector focused on the window 670 or it may utilize a received optical signal 135, or lack thereof, to identify the existence of an obscurant on the window. In some embodiments, an obstruction detector may detect the existence or status of an obscurant 680 on either the internal window 670, an external window, or both windows.

An obstruction detector may exist within controller 150 or may be separate hardware or software that sensor 600 uses to identify when the emitted optical signal 125 is blocked or obscured by something.

In some embodiments, the controller 150 may use the status from an obstruction detector to optimize the emitted optical signal to reduce the obscurant, and it may continue to change the characteristics of the light source 110 or scanner 120 in response to status updates from the obstruction detection system. In an example embodiment, a point cloud of a lidar sensor 600 may be used to assess the impact of an attempt to clear the obscurant 680 from the window 670.

In some embodiments, to detect the presence of an obscurant on the window, one or more dedicated sensors, such as a rain sensor, an air pressure sensor, and/or another sensor capable of detecting conditions indicative of current weather, may be included in the sensor system 600. In such case, a controller 150 may be communicatively coupled to the one or more sensors to receive an indication that there may be an obscurant on the window.

In other embodiments, the sensor system 600 may not utilize dedicated sensors to detect an obscurant 680, and instead rely on properties of input beam 135 to determine that an obscurant 680 may be present on the window 670. Depending on the composition, an obscurant 680 may reflect or scatter much of the emitted optical signal 125, effectively creating an early return signal, or conversely, absorb much of the optical signal effectively reducing the return signal 135. The sensor 600 in these implementations may include a controller 150 coupled to the receiver 140. When the receiver 140 does not detect a return light pulse within the same angular region within the field of regard during a certain time period for a certain number of scan frames, or when the light pulse returns within a threshold timeframe (e.g. too early), the controller 150 may determine that the view is probably blocked at that particular orientation by an obscurant 680.

Additionally or alternatively, the sensor 600 may conduct a diagnostic routine to detect whether any portions of the field of regard are obscured. Upon identifying such areas, the sensor 600 may initiate a remedial procedure to reduce the obscurant 680. As an example, in a case where it is not possible to generate full point cloud data because the window is covered by an obscurant, the sensor can be directed into a “laser window clean” mode, which may include a unique scan pattern or light source settings. The status of window cleaning may be directly monitorable via the obstruction detection system. In some embodiments, the sensor 600 then may execute the diagnostic routine again to see whether the remedial action had any effect on the field of regard. In one embodiment, the sensor 600 may receive an indication from another source, such as a camera mounted on the vehicle, that the vehicle currently is not facing any objects within the maximum distance at which the sensor 600 operates, in the entire field of regard or a specified portion of the field of regard. The sensor 600 accordingly may emit optical signals and determine whether any of the signals are reflected back.

The sensor 600 also may generate one or more indications for the operator, passenger, or driver of the vehicle to indicate that an obscurant 680 is likely present on the surface of the window 670. The sensor 600 may generate these indications in addition to attempting to clear the obscurant 680 by using absorption of the emitted optical signal. In some cases, the sensor 600 may (1) determine the likely presence of an obscurant 680, (2) attempt to clear the obscurant 680 using characteristics of the light source 110 or the scan pattern used by the scanner 120, (3) determine whether the obscurant is still being observed, and then (4) generate an indication for the operator only if the remedial action appears to have been unsuccessful.

In an example embodiment, the sensor is a lidar system that includes a light source configured to emit an optical signal, a scanner that scans the optical signal across a field of regard of the lidar system, and a receiver to detect light from the emitted optical signal that is scattered by a target. The lidar system may further include a window, through which optical signals are emitted and/or received, and the window may have an obscurant such as water, ice, frost or fog on it that partially or fully obstructs the path of the optical signals. The lidar system may use the light source to reduce the obscurant on the window 670, or an external windshield 800, by directing light at the window that is well absorbed by the obscurant. Such absorption may create heat in the obscurant that works to melt or evaporate the obscurant. The obscurant may be reduced by such light directed at it thus reducing the impact to the optical signals, allowing the lidar system to obtain correct information about its environment.

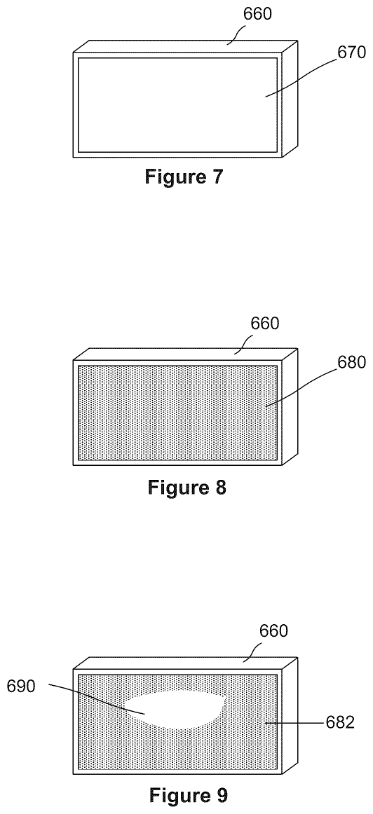

FIGS. 7-9 illustrate examples of sensor windows 670 that are free from obscurant (FIG. 7), fully obscured by an obscurant 680 (FIG. 8), and partially obscured by an obscurant 682 (FIG. 9), respectively.

As an example, a lidar system that has been exposed to the elements in an environment below freezing may have a build up of ice existing on the sensor window 670 as the lidar system is beginning operation, for example as depicted in FIG. 8. The sensor 600 may direct light from the light source 110 toward the window 670 in a particular way so as to melt the ice by heating it up when the laser light is absorbed by the ice. In some cases, the sensor may focus on the central area of the window first, to allow it to begin obtaining sensor data in the middle of the field of regard as the ice melts, resulting in a partially cleared window 690 as depicted in FIG. 9. As the ice continues to melt, the window becomes clear of ice, as depicted in FIG. 7.

In some embodiments, the sensor may focus evenly on the entire viewing area. In other embodiments, the sensor may focus on a particular area of interest to clear first within the field of regard. As an example, the scan pattern for obscurant removal may be unique relative to the scan pattern used for standard imaging.

In some implementations, there may be zero, one, two or more windows through which the optical signal is directed. As an example, a sensor may include an internal window for sealing the lidar system and an external window such as a windshield.

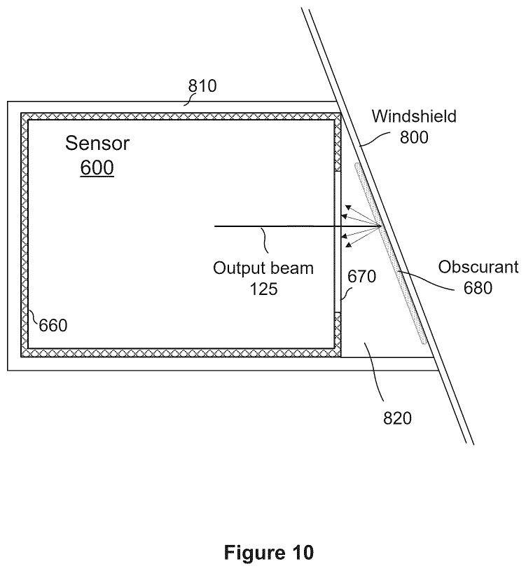

FIG. 10 illustrates an example sensor 600 with a window 670 behind an external window where a gap 820 exists between them.

The external window may also be referred to as a windshield 800, and may be a cover that protects the system 600 but might not be airtight or watertight. As an example, it may be the windshield 800 of a vehicle, and the sensor 600 may be operating in the vehicle. The internal window 670 may provide an airtight, watertight, or hermetic seal that prevents water vapor, liquid water, dirt, dust, or other contaminants from getting inside the housing 660. Prior to being sealed, the housing 660 may be filled or purged with a dry or inert gas, such as for example, dry air, nitrogen, or argon. As an example, a housing 660 may include a window 670 positioned behind, and in addition to, a windshield 800 of a vehicle. An obscurant may exist on either side of either window.

A gap 820 may exist between the internal and external windows. A gap 820 may also be referred to as a space, vacuum, or void. A gap 820 may consist of any suitable medium such as air, other gas or gases, or a vacuum. The gap 820 may be further enclosed by an external housing 810 that may surround the sensor housing 660 to attach the sensor 600 to the external window 800.

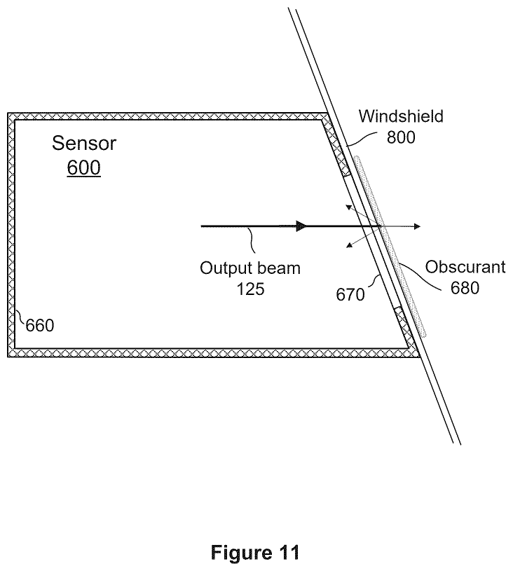

Alternatively, the two windows may be mounted flush against each other, as for example in FIG. 11.

FIG. 11 illustrates an example sensor 600 with a window 670 and a windshield 800 that sits flush against the window 670, without a gap between them.

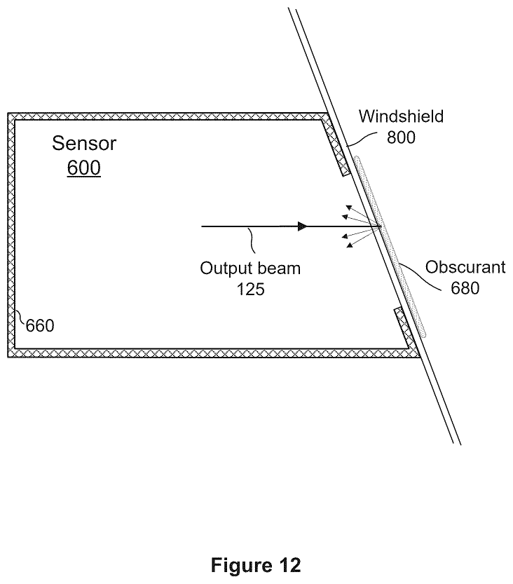

In another embodiment, the housing 660 may not include a window 670 but instead have an opening in the housing 660 and be mounted against an external window, such as a windshield 800, as for example in FIG. 12.

FIG. 12 illustrates an example sensor 600 with a windshield 800 in front of the sensor 600 where the sensor housing 660 does not fully enclose the system and does not include a window. As an example, sensor 600 may have an opening instead of a window and the sensor may be mounted adjacent to an external window, such as a windshield 800.

Surface A or Surface B of the window 670, or either surface of an external window, may acquire an obscurant 680 such as water, ice, frost, dew, mist, rain or fog before or during the sensor 600 operation. As an example, a window 670 operating in an environment below the freezing temperature of water may develop frost or ice on the exterior surface. In other examples, the window 670 or windshield 800 may develop fog on the internal surface in some environments. As examples, an obscurant may form on the interior of windshield 800, as in FIG. 10, the exterior surface of sensor window 670, as in FIG. 6, or on the outside of a windshield 800, as in FIGS. 11-12.

In certain embodiments, the obscurant 680 may block, scatter, or deflect output beam 125 as it exits the sensor, or input beam 135 as it enters. The obscurant 680 may block the output signal 125 entirely (as depicted in FIG. 10), or it may scatter or absorb parts of the signal letting some of the signal pass through to the target 130 (as depicted in FIG. 11).

In such cases, the sensor system may not obtain accurate information about the environment across the field of regard.

In certain embodiments where there is a gap 820 between windows, an obscurant 680 that develops may be difficult to remove because of the multiple surfaces separated from each other (See, e.g., FIG. 10). For example, some systems use wipers, fluid or conductive heating to reduce an obscurant, but where the obscurant 680 is in the gap 820 between the two windows, such as the internal surface of the exterior window 800 in FIG. 10, or the external surface of the interior window 670, such methods would be difficult to implement and may be of limited efficacy. As an example, conductive heating may have low efficacy in the case where a vacuum exists in the gap 820 between windows. There may be an advantage to using the light source 110 to reduce the obscurant 680 by absorption because the light passes through both of the windows thus reaching an obscurant 680 even when it is located in between windows, and even in the case of a vacuum between the two windows. In this way, the light source 110 may be more effective than physical (e.g. wipers or fluid) or conductive heating/cleaning mechanisms.

In certain embodiments, a conductive heating mechanism may be used in conjunction with the light source 110 to remove obscurants. In such cases, the conductive heating mechanism may be disposed outside or inside of the field of regard of the sensor system. As an example, a conductive heating mechanism may melt ice from the edges of a sensor window 670. Disposing the conductive heating mechanism outside of the field of regard may provide certain advantages to the system. For example, if the heating element mechanism is applied to the window 670 outside of the field of regard of the sensor 600 to reduce obscurants nearby, and the light source 110 is used to reduce obscurants within the field of regard, such sensor may avoid having its field of regard obscured by a conductive heating element and may be able to obtain improved window cleaning and data collection.

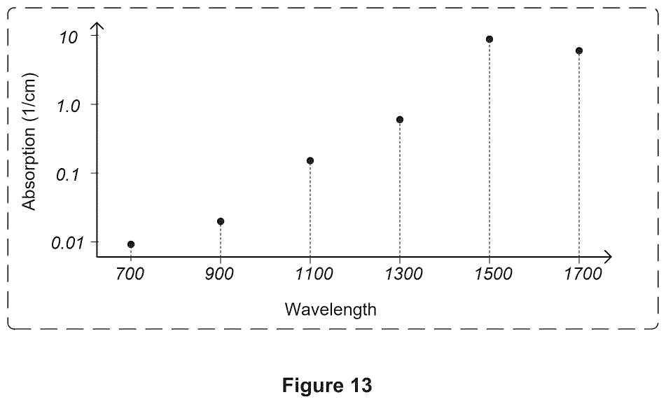

FIG. 13 illustrates generally the relationship between a wavelength of light and its absorption by water. Lidar sensors frequently may be operated at a wavelength between approximately 900 and 1800 nm. As illustrated by the graph, where a sensor uses a wavelength of approximately 1500 nm it may result in better absorption of that optical signal by an obscurant such as water, ice, frost, dew, mist, or fog than at wavelengths near 900 nm, because absorption of that light by water is greater at approximately a 1500 nm wavelength than at approximately a 900 nm wavelength.

Sensors operating between approximately 1400 nm and 1700 nm may be particularly advantageous from the perspective of reducing obscurants related to water because such a signal is strongly absorbed by water. As such, using the light source 110 to defrost or defog a sensor window may be more efficient than conventional heating or cleaning methods, such as using conductive heating mechanisms or windshield wipers or fluids. In particular, in the case of multiple windows such as when a sensor 600 is mounted behind a windshield, including when there is a gap between the windows, using a light source for heating by absorption may be advantageous.

In an example embodiment, a light source 110 of a sensor 600 may be configured to emit an optical signal 125 having a wavelength in a range between 1400 nanometers and 1700 nanometers, to optimize absorption of the light by obscurants. In other examples, a sensor 600 may use a wavelength between 850 and 1000 nanometers to clear water-based obscurants based on absorption of the light, even though the effect may be less pronounced than at wavelengths near 1400-1700 nanometers.

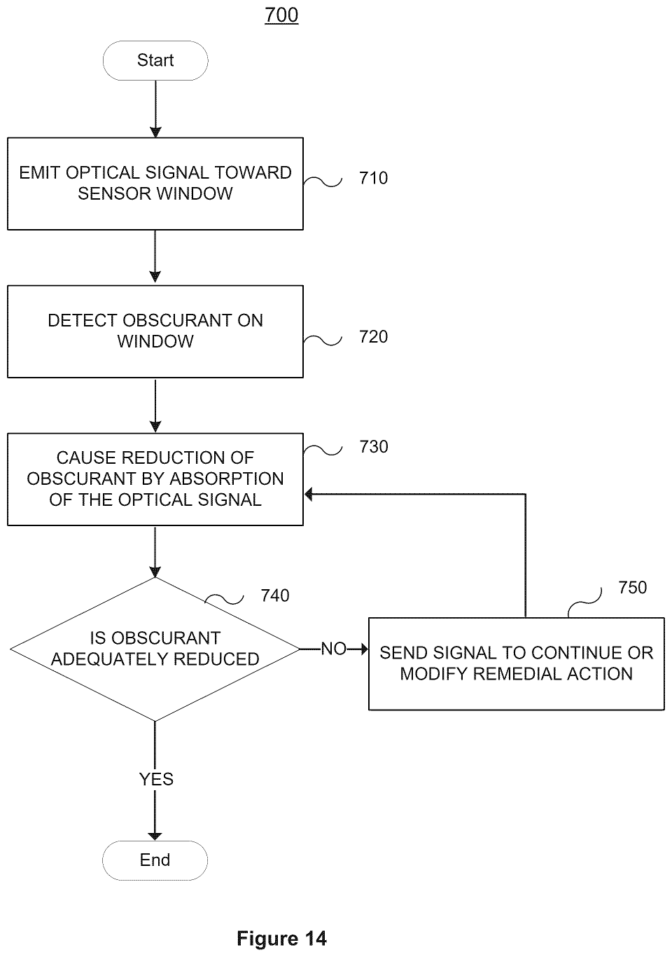

FIG. 14 illustrates an example method 700 for reducing an obscurant 680 on a window 670 of a sensor 600. The method may begin at step 710, where an optical signal may be emitted toward the window of a sensor. At step 720, the existence of an obscurant on a window of the sensor may be detected. At step 730, the sensor may initiate a remedial action to reduce the obscurant by absorption of the optical signal. At step 740, the sensor 600 may determine whether the obscurant was adequately reduced and, if so, the method would end. Alternatively, if in step 740 the sensor 600 determined the obscurant was not adequately reduced, in step 750 a signal may be sent to continue or modify the remedial action to cause further reduction of the obscurant, returning to step 730. Once the obscurant is adequately reduced, the sensor may begin obtaining information about the environment of the sensor from the received signal.

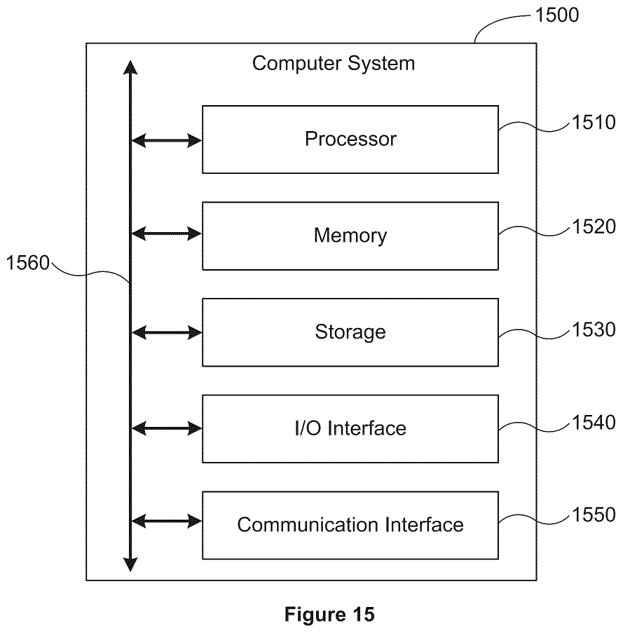

FIG. 15 illustrates an example computer system 1500. One or more computer systems 1500 may perform one or more steps of one or more methods described or illustrated herein. One or more computer systems 1500 may provide functionality described or illustrated herein. Software running on one or more computer systems 1500 may perform one or more steps of one or more methods described or illustrated herein or may provide functionality described or illustrated herein. In particular embodiments, a computer system may be referred to as a processor, a controller, a computing device, a computing system, a computer, a general-purpose computer, or a data-processing apparatus. For example, controller 150 in FIG. 1 may be referred to or may include a computer system. Herein, reference to a computer system may encompass one or more computer systems, where appropriate. In some embodiments, computer system 1500 may be used to perform one or more of the processes discussed herein, such as the process in FIG. 14.

Computer system 1500 may take any suitable physical form. As an example, computer system 1500 may be an embedded computer system, a system-on-chip (SOC), an application-specific integrated circuit (ASIC), a field-programmable gate array (FPGA), a single-board computer system (SBC), a desktop computer system, a laptop or notebook computer system, a mainframe, a mesh of computer systems, a server, a tablet computer system, or any suitable combination of two or more of these. As another example, all or part of computer system 1500 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, sensor, lidar system, ADAS, autonomous vehicle, autonomous-vehicle driving system, cockpit control, camera view display (e.g., display of a rear-view camera in a vehicle), eyewear, or head-mounted display. Where appropriate, computer system 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

As illustrated in the example of FIG. 15, computer system 1500 may include a processor 1510, memory 1520, storage 1530, an input/output (I/O) interface 1540, a communication interface 1550, or a bus 1560. Computer system 1500 may include any suitable number of any suitable components in any suitable arrangement.

Processor 1510 may include hardware for executing instructions, such as those making up a computer program. As an example, to execute instructions, processor 1510 may retrieve (or fetch) the instructions from an internal register, an internal cache, memory 1520, or storage 1530; decode and execute them; and then write one or more results to an internal register, an internal cache, memory 1520, or storage 1530. A processor 1510 may include one or more internal caches for data, instructions, or addresses. Processor 1510 may include any suitable number of any suitable internal caches, where appropriate. As an example, processor 1510 may include one or more instruction caches, one or more data caches, or one or more translation lookaside buffers (TLBs). Instructions in the instruction caches may be copies of instructions in memory 1520 or storage 1530, and the instruction caches may speed up retrieval of those instructions by processor 1510. Data in the data caches may be copies of data in memory 1520 or storage 1530 for instructions executing at processor 1510 to operate on; the results of previous instructions executed at processor 1510 for access by subsequent instructions executing at processor 1510 or for writing to memory 1520 or storage 1530; or other suitable data. The data caches may speed up read or write operations by processor 1510. The TLBs may speed up virtual-address translation for processor 1510. Processor 1510 may include one or more internal registers for data, instructions, or addresses. Processor 1510 may include any suitable number of any suitable internal registers, where appropriate. Where appropriate, processor 1510 may include one or more arithmetic logic units (ALUs); may be a multi-core processor; or may include one or more processors 1510.

Memory 1520 may include main memory for storing instructions for processor 1510 to execute or data for processor 1510 to operate on. As an example, computer system 1500 may load instructions from storage 1530 or another source (such as, for example, another computer system 1500) to memory 1520. Processor 1510 may then load the instructions from memory 1520 to an internal register or internal cache. To execute the instructions, processor 1510 may retrieve the instructions from the internal register or internal cache and decode them. During or after execution of the instructions, processor 1510 may write one or more results (which may be intermediate or final results) to the internal register or internal cache. Processor 1510 may then write one or more of those results to memory 1520. One or more memory buses (which may each include an address bus and a data bus) may couple processor 1510 to memory 1520. Bus 1560 may include one or more memory buses. One or more memory management units (MMUs) may reside between processor 1510 and memory 1520 and facilitate accesses to memory 1520 requested by processor 1510. Memory 1520 may include random access memory (RAM). This RAM may be volatile memory, where appropriate. Where appropriate, this RAM may be dynamic RAM (DRAM) or static RAM (SRAM). Memory 1520 may include one or more memories 1520, where appropriate.

Storage 1530 may include mass storage for data or instructions. As an example, storage 1530 may include a hard disk drive (HDD), a floppy disk drive, flash memory, an optical disc, a magneto-optical disc, magnetic tape, or a Universal Serial Bus (USB) drive or a combination of two or more of these. Storage 1530 may include removable or non-removable (or fixed) media, where appropriate. Storage 1530 may be internal or external to computer system 1500, where appropriate. Storage 1530 may be non-volatile, solid-state memory. Storage 1530 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 1530 may include one or more storage control units facilitating communication between processor 1510 and storage 1530, where appropriate. Where appropriate, storage 1530 may include one or more storages 1530.

I/O interface 1540 may include hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 1540 may include one or more device or software drivers enabling processor 1510 to drive one or more of these I/O devices. I/O interface 1540 may include one or more I/O interfaces 1540, where appropriate.

Communication interface 1550 may include hardware, software, or both providing one or more interfaces for communication (such as, for example, packet-based communication) between computer system 1500 and one or more other computer systems 1500 or one or more networks. As an example, communication interface 1550 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 1500 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 1500 may communicate using fiber-optic communication based on 100 Gigabit Ethernet (100 GbE), 10 Gigabit Ethernet (10 GbE), or Synchronous Optical Networking (SONET). Computer system 1500 may include any suitable communication interface 1550 for any of these networks, where appropriate. Communication interface 1550 may include one or more communication interfaces 1550, where appropriate.

Bus 1560 may include hardware, software, or both coupling components of computer system 1500 to each other. As an example, bus 1560 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 1560 may include one or more buses 1560, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 1500. As an example, computer software may include instructions configured to be executed by processor 1510. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

One or more of the figures described herein may include example data that is prophetic. For example, the example graph illustrated in FIG. 13 may include or may be referred to as prophetic examples.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

1. A sensor comprising:
a light source configured to emit an optical signal toward a window, wherein the emitted optical signal is configured to:
reduce an obscurant on the window through optical absorption by the obscurant of at least a portion of the emitted optical signal; and
scatter from a target located a distance from the sensor;
a receiver configured to detect a received optical signal, the received optical signal comprising a portion of the emitted optical signal scattered from the target and transmitted through the window; and
a controller configured to determine a characteristic of the target based on the received optical signal.

2. The sensor of claim 1, wherein reducing the obscurant comprises melting, sublimating, or evaporating the obscurant.

3. The sensor of claim 1, wherein the obscurant comprises ice and reducing the obscurant comprises melting the ice.

4. The sensor of claim 1, wherein the window is (1) part of a windshield of a vehicle that the sensor is part of, or (2) part of an enclosure of the sensor.

5. The sensor of claim 1, wherein the characteristic of the target is a distance to the target and determining the distance is based on a time-of-arrival for the received optical signal.

6. The sensor of claim 1, wherein the sensor further comprises a conductive heating mechanism disposed outside a field of regard of the sensor.

7. The sensor of claim 1, wherein the sensor includes only one light source.

8. The sensor of claim 1, wherein the emitted optical signal is configured to have a wavelength between about 1400 nanometers and about 1700 nanometers.

9. The sensor of claim 1, wherein the controller is further configured to adjust a scan pattern of the sensor to reduce the obscurant on the window.

10. The sensor of claim 9, wherein adjusting the scan pattern comprises slowing a rate at which the emitted optical signal is scanned in a particular region of the window.

11. The sensor of claim 1, wherein the controller is further configured to adjust a peak power, average power, or pulse energy of the emitted optical signal to modify the sensor's ability to reduce the obscurant on the window.

12. The sensor of claim 1, further comprising a scanner configured to scan the emitted optical signal across a field of regard of the sensor thereby scanning the emitted optical signal across a region of the window.

13. The sensor of claim 1, wherein the sensor is a lidar system and the emitted optical signal comprises an emitted pulse of light.

14. The sensor of claim 1, wherein the obscurant comprises water, frost, ice, dew, mist, or fog.

15. The sensor of claim 1, wherein:
the window is a first window;
the emitted optical signal travels through a second window; and
the obscurant is located on the first or the second window.

16. The sensor of claim 15, wherein:
the first window is part of a sensor housing;
the second window is part of a vehicle; and
a gap exists between the first and second windows.

17. The sensor of claim 1, wherein the obscurant at least partially prevents the emitted optical signal from reaching the target.

18. The sensor of claim 1, further comprising an obstruction detection system configured to monitor a status of the obscurant on the window.

19. A lidar system comprising:
a light source configured to emit an optical signal toward a window wherein the emitted optical signal is configured to:
reduce an obscurant on the window through optical absorption by the obscurant of at least a portion of the emitted optical signal; and
scatter from a target located a distance from the system;
a scanner configured to scan the optical signal across a field of regard of the system;
a receiver configured to detect a received optical signal, the received optical signal comprising a portion of the emitted optical signal scattered by the target and transmitted through the window; and
a controller configured to determine a characteristic of the target based on the received optical signal.

20. A method comprising:
emitting, by a light source of a sensor, an output signal toward a window;
detecting, by the sensor, an obscurant on the window;
reducing, by absorption of the output signal, an obscurant on the window; and
obtaining information about an environment of the sensor from a received signal.
